(19) United States
(12) Patent Application Publication
(10) Pub. No.: US 2025/0253703 A1
(43) Pub. Date: Aug. 7, 2025

(54) METHOD FOR DIRECTLY CHARGING BATTERY, APPARATUS, SYSTEM AND DEVICE FOR DIRECTLY CHARGING BATTERY BASED ON PHOTOVOLTAIC PANELS

(71) Applicant: BEIJING LEI RAN CYCLE TECHNOLOGY CO., LTD, Beijing (CN)

(72) Inventor: Leiran Xiu, Beijing (CN)

(21) Appl. No.: 18/986,717

(22) Filed: Dec. 19, 2024

Related U.S. Application Data
(63) Continuation of application No. PCT/CN2023/105154, filed on Jun. 30, 2023.

(30) Foreign Application Priority Data
Jul. 22, 2022 (CN) 202210860551.X
Jul. 28, 2022 (CN) 202210901190.9
Oct. 11, 2022 (CN) 202211244257.2

(51) Int. Cl. H02J 7/35; G05F 1/67; H01M 10/44; H02J 1/12; H02J 7/00

(52) U.S. Cl. CPC H02J 7/35; G05F 1/67; H01M 10/44; H02J 1/12; H02J 7/0029; H02J 7/007182; H02J 2207/20

(57) ABSTRACT

A method, an apparatus, a system and a device for directly charging a battery based on photovoltaic panels are disclose, which belongs to the field of new energy technologies. The method includes firstly adjusting the number of series-connected photovoltaic panels of each photovoltaic panel series branch according to the desired battery charging voltage of the secondary battery, the current number of series-connected photovoltaic panels of each photovoltaic panel series branch and the current maximum power point voltage, to ensure that the maximum power point voltage of each photovoltaic panel series branch can match the desired battery charging voltage.

### TECHNICAL FIELD

The disclosure relates to the field of new energy technologies, and more specifically, to an apparatus, a system and a device for directly charging a battery based on photovoltaic panels.

### BACKGROUND ART

A secondary battery, also referred to as a rechargeable battery or a storage battery, is a battery that can continue to be used by activating an active material by charging after the battery is discharged. Conventional processes for charging the secondary battery generally include the step of converting alternating current into direct current at first, then properly regulating the voltage of the direct current, and finally charging the battery by utilizing the voltage-regulated direct current. However, this kind of battery charging causes large power losses and meanwhile requires a high hardware cost.

Photovoltaic panels, also known as photovoltaic panel assemblies, are power generation devices that produce direct current upon exposure to sunlight, and consist of thin solid photovoltaic cells made almost entirely of a semiconductor material (e.g., silicon). Since the photovoltaic panel outputs direct current, how to directly charge the secondary battery by using the photovoltaic panel, and further achieve the purposes of reducing power consumption, improving charging efficiency and reducing hardware cost, is a subject to be urgently researched by those skilled in the art.

### SUMMARY

An object of the disclosure is to provide a method, an apparatus, a system and a device for directly charging a battery based on photovoltaic panels, to solve based on photovoltaic panels the problems with the conventional battery charging manners such as large power loss and high hardware cost.

In order to achieve the object, the disclosure employs the following technical solutions:

In a first aspect, there is provided a method for directly charging a battery based on photovoltaic panels, the method being executed by a based on photovoltaic panels voltage conversion controller of a charging system, wherein the charging system further includes a photovoltaic panel voltage conversion circuit, a direct charging switch and a secondary battery, where the photovoltaic panel voltage conversion circuit includes one photovoltaic panel series branch or at least two photovoltaic panel series branches, the one photovoltaic panel series branch or each of the at least two photovoltaic panel series branches comprises a plurality of series-connected photovoltaic panels. The photovoltaic voltage conversion circuit may synchronously adjust a number of series-connected photovoltaic panels of all the photovoltaic panel series branch and meanwhile re-combine the adjusted plurality of photovoltaic panels into at least one new photovoltaic panel series branch to charge the secondary battery or transmit electricity to the external, or the photovoltaic voltage conversion circuit only selects one of the photovoltaic panel series branches to charge the secondary battery and transmits the electricity on remaining photovoltaic panel series branches to the external. The voltage conversion controller respectively communicatively connects the photovoltaic panel voltage conversion circuit and the direct charging switch, a positive electrode of each photovoltaic panel series branch is electrically connected to a positive input terminal of the direct charging switch, a negative electrode of each photovoltaic panel series branch is electrically connected to a negative input terminal of the direct charging switch, the positive output terminal of the direct charging switch is electrically connected to the positive electrode of the secondary battery, and the negative output terminal of the direct charging switch is electrically connected to the negative electrode of the secondary battery;

The method for directly charging a battery includes the following steps S1-S5:
S1: according to a desired battery charging voltage of the secondary battery, a current number of series-connected photovoltaic panels and a current maximum power point voltage of each of the photovoltaic panel series branches, determining a target number of series-connected photovoltaic panels which are of the photovoltaic panel series branch and enable the maximum power point voltage to match the desired battery charging voltage, and then performing step S2;
S2: judging whether the target number of series-connected photovoltaic panels is equal to the current number of series-connected photovoltaic panels, if YES, performing step S4, otherwise performing step S3;
S3: generating a first control signal according to the target number of series-connected photovoltaic panels, and transmitting the first control signal to the photovoltaic panel voltage conversion circuit, so that the photovoltaic panel voltage conversion circuit respectively adjusts the number of series-connected photovoltaic panels of each photovoltaic panel series branch to the target number of series-connected photovoltaic panels after responding to the first control signal, and then performing step S4;
S4: judging whether the one photovoltaic panel series branch or the at least two photovoltaic panel series branches are all currently in a normal condition according to a current branch voltage and a current branch current of each photovoltaic panel series branch, and if YES, performing step S5;
S5: generating a second control signal, and transmitting the second control signal to the direct charging switch, so that after responding to the second control signal, the direct charging switch enables the one photovoltaic panel series branch or the at least two photovoltaic panel series branches to form a charging loop with the secondary battery.

Based on the above content of the disclosure, there is provided a new solution for charging a secondary battery using DC current of photovoltaic panels, i.e., adjusting the number of series-connected photovoltaic panels of each photovoltaic panel series branch according to the desired battery charging voltage of the secondary battery, the current number of series-connected photovoltaic panels of each photovoltaic panel series branch and the current maximum power point voltage, to ensure that the maximum power point voltage of each photovoltaic panel series branch can match the desired battery charging voltage; then upon judging that each photovoltaic panel series branch is currently in the normal condition, controlling the direct charging switch to be turned on to form a charging loop, thereby using the DC current of the photovoltaic panels to directly charge the secondary battery, thereby skipping a conversion process of inverting the direct current into the alternating current and rectifying the alternating current into the direct current, and achieving the purposes of reducing power consumption, improving charging efficiency and reducing hardware cost.

In a possible design, when the charging system further comprises a photovoltaic inverter and a power grid, and the voltage conversion controller is further communicatively connected to the photovoltaic inverter, positive electrodes of the photovoltaic panel series branches are further respectively electrically connected to the positive input terminal of the photovoltaic inverter, and negative electrodes of the photovoltaic panel series branches are further respectively electrically connected to the negative input terminal of the photovoltaic inverter; and when an AC output terminal of the photovoltaic inverter is electrically connected to the power grid, the method for directly charging a battery further comprises the following step S6 after step S5: generating a third control signal, and transmitting the third control signal to the photovoltaic inverter, so that the photovoltaic inverter enters a battery charging mode in cooperation with the voltage conversion controller after responding to the third control signal: on the one hand, according to the desired battery charging current of the secondary battery, adjusting a magnitude of the current transmitted to the secondary battery in real time according to the maximum power point voltage, so that the battery charging voltage always operates at the maximum power point, and on the other hand, inverting and transmitting the remaining photovoltaic power generation amount of the photovoltaic panel voltage conversion circuit to the power grid.

In a possible design, the charging system further comprises a DC-DC buck-boost circuit, the voltage conversion controller is also communicatively connected to said DC-DC buck-boost circuit, and the positive electrodes of the photovoltaic panel series branches are also respectively electrically connected to a positive electrode input terminal of said DC-DC buck-boost circuit, the negative electrodes of the photovoltaic panel series branches are also respectively electrically connected to a negative electrode input terminal of the DC-DC buck-boost circuit, the positive electrode output terminal of the DC-DC buck-boost circuit is electrically connected to the positive electrode of the secondary battery, when the negative electrode output terminal of the DC-DC buck-boost circuit is electrically connected to the negative electrode of the secondary battery, the method for directly charging a battery further comprises the following step after step S5: generating an eighth control signal and transmitting the eighth control signal to the DC-DC buck-boost circuit, so that the DC-DC buck-boost circuit enters a battery charging mode in cooperation with the voltage conversion controller after responding to the eighth control signal: on the one hand, according to the desired battery charging current of the secondary battery, adjusting a magnitude of the current transmitted to the secondary battery in real time according to the maximum power point voltage, so that the battery charging voltage always operates at the maximum power point; and on the other hand, transmitting the remaining photovoltaic power generation amount of the photovoltaic panel voltage conversion circuit to the secondary battery after bucking or boosting the voltage via the DC-DC buck-boost circuit.

In a possible design, after performing step S6, the method further comprises the following steps S711-S714:
S711: judging whether the desired battery charging voltage of the secondary battery matches the current maximum power point voltage of each photovoltaic panel series branch, and if NO, executing step S712;
S712: adjusting to reduce the current magnitude until the current magnitude is not larger than a preset current threshold, and executing step S713;
S713: generating a fourth control signal, transmitting the fourth control signal to the direct charging switch, so that the direct charging switch cuts off the charging loop after responding to the fourth control signal, and then executing step S714;
S714: returning to execute steps S1 to S6.

In a possible design, after performing step S6, the method further comprises the following steps S721-S726:
S721: if it is found according to battery status data of the secondary battery that the charging of the secondary battery needs to be stopped, executing step S722;
S722: executing step S723 after the adjusting to reduce the current magnitude until the current magnitude is not larger than the preset current threshold;
S723: generating a fourth control signal, transmitting the fourth control signal to the direct charging switch, so that the direct charging switch cuts off the charging loop after responding to the fourth control signal, and then executing step S724;
S724: judging whether the current number of series-connected photovoltaic panels of each of the photovoltaic panel series branches is equal to a maximum adjustable integer value, if YES, executing step S726, and otherwise, executing step S725;
S725: generating a fifth control signal, and transmitting the fifth control signal to the photovoltaic panel voltage conversion circuit, so that the photovoltaic panel voltage conversion circuit respectively adjusts the number of series-connected photovoltaic panels of each of the photovoltaic panel series branches to the maximum adjustable integer value after responding to the fifth control signal, and then executing step S726;
S726: generating a sixth control signal, and transmitting the sixth control signal to the photovoltaic inverter, so that the photovoltaic inverter, after responding to the sixth control signal, enters a normal working mode: inverting and transmitting all the photovoltaic power generation amount of the photovoltaic panel voltage conversion circuit to the power grid.

In a possible design, the step of, the step of, according to a desired battery charging voltage of the secondary battery, a current number of series-connected photovoltaic panels and a current maximum power point voltage of each of the photovoltaic panel series branches, determining a target number of series-connected photovoltaic panels which are of the photovoltaic panel series branch and enable the maximum power point voltage to match the desired battery charging voltage comprises: judging whether the secondary battery can be charged according to the maximum power point voltage of each photovoltaic panel series branch as recorded in the latest unit time period;
if YES, determining the target number of series-connected photovoltaic panels which are of the photovoltaic panel series branch and enable the maximum power point voltage to match the desired battery charging voltage, according to the desired battery charging voltage of the secondary battery, the current number of series-connected photovoltaic panels and the current maximum power point voltage of each of the photovoltaic panel series branches, otherwise triggering to generate and display reminding information indicating that the secondary battery is not chargeable currently.

In a possible design, after judging that the one photovoltaic panel series branch or the at least two photovoltaic panel series branches are all currently in a normal condition, the method further comprises:
if the photovoltaic panel series branch or any of the at least two photovoltaic panel series branches is judged currently in an abnormal condition, triggering to generate and display reminding information indicating that the battery cannot be currently charged.

In a second aspect, there is provided an apparatus for charging a battery based on photovoltaic panels, adapted to be arranged in a voltage conversion controller of a charging system, wherein the charging system further includes a photovoltaic panel voltage conversion circuit, a direct charging switch and a secondary battery, where the photovoltaic panel voltage conversion circuit includes one photovoltaic panel series branch or at least two photovoltaic panel series branches, the one photovoltaic panel series branch or each of the at least two photovoltaic panel series branches comprises a plurality of series-connected photovoltaic panels. The photovoltaic voltage conversion circuit may synchronously adjust a number of series-connected photovoltaic panels of all the photovoltaic panel series branch and meanwhile re-combine the adjusted plurality of photovoltaic panels into at least one new photovoltaic panel series branch to charge the secondary battery or transmit electricity to the external, or the photovoltaic voltage conversion circuit only selects one of the photovoltaic panel series branches to charge the secondary battery and transmits the electricity on remaining photovoltaic panel series branches to the external. The voltage conversion controller respectively communicatively connects the photovoltaic panel voltage conversion circuit and the direct charging switch, a positive electrode of each photovoltaic panel series branch is electrically connected to a positive input terminal of the direct charging switch, a negative electrode of each photovoltaic panel series branch is electrically connected to a negative input terminal of the direct charging switch, the positive output terminal of the direct charging switch is electrically connected to the positive electrode of the secondary battery, and the negative output terminal of the direct charging switch is electrically connected to the negative electrode of the secondary battery;
the apparatus for directly charging the battery comprises a target number determination module, a first judgment module, a first trigger module, a second judgment module and a second trigger module;
the target number determination module is communicatively connected to the first judgment module and configured to, according to a desired battery charging voltage of the secondary battery, a current number of series-connected photovoltaic panels and a current maximum power point voltage of each of the photovoltaic panel series branches, determine a target number of series-connected photovoltaic panels which are of the photovoltaic panel series branch and enable the maximum power point voltage to match the desired battery charging voltage, and then activate the first judgment module;
the first judgment module is communicatively connected with the first trigger module and the second judgment module, respectively, and configured to judge whether the target number of series-connected photovoltaic panels is equal to the current number of series-connected photovoltaic panels, if YES, activate the second judgment module, otherwise, activate the first trigger module;
the first trigger module is communicatively connected with the second judgment module and configured to generate a first control signal according to the target number of series-connected photovoltaic panels, and transmit the first control signal to the photovoltaic panel voltage conversion circuit, so that the photovoltaic panel voltage conversion circuit respectively adjusts the number of series-connected photovoltaic panels of each photovoltaic panel series branch to the target number of series-connected photovoltaic panels after responding to the first control signal, and then activate the second judgment module;
the second judgment module is communicatively connected with the second trigger module and configured to judge whether the one photovoltaic panel series branch or the at least two photovoltaic panel series branches are all currently in a normal condition according to a current branch voltage and a current branch current of each photovoltaic panel series branch, and if YES, activate the second trigger module;
the second trigger module is configured to generate a second control signal, and transmit the second control signal to the direct charging switch, so that after responding to the second control signal, the direct charging switch enables the one photovoltaic panel series branch or the at least two photovoltaic panel series branches to form a charging loop with the secondary battery.

In a possible design, when the charging system further comprises a photovoltaic inverter and a power grid, and the voltage conversion controller is further communicatively connected to the photovoltaic inverter, the positive electrodes of the photovoltaic panel series branches are further respectively electrically connected to the positive input terminal of the photovoltaic inverter, and the negative electrodes of the photovoltaic panel series branches are further respectively electrically connected to the negative input terminal of the photovoltaic inverter; and an AC output terminal of the photovoltaic inverter is electrically connected to the power grid, the virtual device further includes a third trigger module communicatively connected to the second trigger module;
the third trigger module is configured to, after the second control signal is transmitted to the direct charging switch, trigger to generate a third control signal, and transmit the third control signal to the photovoltaic inverter, so that the photovoltaic inverter enters a battery charging mode in cooperation with the voltage conversion controller after responding to the third control signal: on the one hand, according to the desired battery charging current of the secondary battery, adjust a magnitude of the current transmitted to the secondary battery in real time according to the maximum power point voltage, so that the battery charging voltage always operates at the maximum power point, and on the other hand, invert and transmit the remaining photovoltaic power generation amount of the photovoltaic panel voltage conversion circuit to the power grid.

In a third aspect, there is provided a charging system, comprising a voltage conversion controller, a photovoltaic panel voltage conversion circuit, a direct charging switch and a secondary battery, wherein the photovoltaic panel voltage conversion circuit includes one photovoltaic panel series branch or at least two photovoltaic panel series branches, the one photovoltaic panel series branch or any of the at least two photovoltaic panel series branches, the one photovoltaic panel series branch or each of the at least two photovoltaic panel series branches comprises a plurality of series-connected photovoltaic panels. The photovoltaic voltage conversion circuit may synchronously adjust a number of series-connected photovoltaic panels of all the photovoltaic panel series branch and meanwhile re-combine the adjusted plurality of photovoltaic panels into at least one new photovoltaic panel series branch to charge the secondary battery or transmit electricity to the external, or the photovoltaic voltage conversion circuit only selects one of the photovoltaic panel series branches to charge the secondary battery and transmits the electricity on remaining photovoltaic panel series branches to the external. The voltage conversion controller respectively communicatively connects the photovoltaic panel voltage conversion circuit and the direct charging switch, a positive electrode of each photovoltaic panel series branch is electrically connected to a positive input terminal of the direct charging switch, a negative electrode of each photovoltaic panel series branch is electrically connected to a negative input terminal of the direct charging switch, the positive output terminal of the direct charging switch is electrically connected to the positive electrode of the secondary battery, and the negative output terminal of the direct charging switch is electrically connected to the negative electrode of the secondary battery;
the voltage conversion controller is used to implement the method for directly charging a battery according to the first aspect or any of possible designs in the first aspect.

In one possible design, when the charging system further comprises a photovoltaic inverter, the photovoltaic panel voltage conversion circuit includes K said photovoltaic panel series branches, where the photovoltaic panel series branches include N photovoltaic panels serially connected in sequence in a direction from a positive electrode to a negative electrode and M switches arranged in sequence in the direction from the positive electrode to the negative electrode direction, an m^{th} switch among the M switches in the direction from the positive electrode to the negative electrode is a first switch, an M^{th} switch among the M switches in the direction from the positive electrode to the negative electrode is a second switch, K represents a positive integer, M represents a positive integer not less than 2, and M represents a positive integer less than M;
the first switcher includes pin #1, pin #2, pin #3, pin #4, pin #5 and pin #6, where when the first switch is in a first state, only pin #3 is electrically connected with pin #4 and pin #2 is electrically connected with pin #6; when the first switch is in a second state, only pin #1 is electrically connected with pin #2 and pin #3 respectively, and pin #4 is electrically connected with pin #5;
the second switch includes pin #2, pin #3, pin #4, pin #5 and pin #6, wherein when the second switcher is in the first state, only pin #3 is electrically connected with pin #4 and pin #2 is electrically connected with pin #6; when the second switcher is in the second state, only pin #3 is electrically connected with pin #6 and pin #4 is electrically connected with pin #5;
the positive electrode of the (M+1)th photovoltaic panel among the N photovoltaic panels in the direction from the positive electrode to the negative electrode is electrically connected with pin #3 of the M^{th} switch, the negative electrode of the M^{th} photovoltaic panel among the N photovoltaic panels in the direction from the positive electrode to the negative electrode is electrically connected to pin #4 of the M^{th} switch, the positive electrode of the (m+1)^{th} photovoltaic panel among the N photovoltaic panels in the direction from the positive electrode to the negative electrode is electrically connected to pin #3 of the m^{th} switch, and the negative electrode of the m^{th} photovoltaic panel among the N photovoltaic panels in the direction from the positive electrode to the negative electrode is electrically connected to pin #4 of the m^{th} switch;
for the first photovoltaic panel series branch of the K photovoltaic panel series branches, the corresponding pin #1 of the m^{th} switch, the corresponding pins #2 of the M switches and the corresponding positive electrode of the first photovoltaic panel in the direction from the positive electrode to the negative electrode are respectively electrically connected to a positive electrode input terminal of the photovoltaic inverter, and the corresponding pins #6 of the M switches are respectively electrically connected to the positive electrode input terminal of the photovoltaic inverter;
for the k^{th} photovoltaic panel series branch in the K photovoltaic panel series branches, the corresponding pins #2 of the corresponding M switches and the positive electrode of the corresponding first photovoltaic panel in the direction from the positive electrode to the negative electrode are respectively electrically connected to pin #5 of the first switch in the (k−1)^{th} photovoltaic panel series branch in the direction from the positive electrode to the negative electrode, and pin #1 of the corresponding w^{th} switch in the direction from the positive electrode to the negative electrode is electrically connected to pin #5 of the (w+1)^{th} switch in the (k−1)^{th} photovoltaic panel series branch in the direction from the positive electrode to the negative electrode; the corresponding pins #6 of the M switches are respectively electrically connected to the positive electrode input terminal of the photovoltaic inverter, wherein k is a positive integer greater than 1 and not greater than K, and w is a positive integer greater than 1 and not greater than M;
for the K^{th} photovoltaic panel series branch of the K photovoltaic panel series branches, the corresponding pins #5 of the M switches are respectively electrically connected to a negative electrode input terminal of the photovoltaic inverter;
the x^{th} switch in each of the photovoltaic panel series branches in the direction from the positive electrode to the negative electrode is synchronously controlled by the voltage conversion controller; furthermore, when the x^{th} switch is in the first state, only the y^{th} switch in the direction from the positive electrode to the negative electrode can be in the second state, wherein x is a positive integer no greater than M, and y is a positive integer less than x.

In a fourth aspect, there is provided a control device, comprising a memory, a processor and a transceiver, wherein the memory is used to store a computer program, the transceiver is used to transmit and receive a message, and the processor is used to read the computer program and implement the method for directly charging a battery according to the first aspect or any of the possible designs in the first aspect.

In a fifth aspect, there is provided a computer-readable storage medium storing instructions that, when executed on a computer, implement the method for directly charging a battery according to the first aspect or any of possible designs in the first aspect.

In a sixth aspect, there is provided a computer program product comprising instructions which, when run on a computer, cause the computer to implement the method for directly charging a battery according to the first aspect or any of possible designs in the first aspect.

Advantageous effects are achieved as follows:
(1) The disclosure provides a new solution for charging a secondary battery using DC current of photovoltaic panels, i.e., adjusting the number of series-connected photovoltaic panels of each photovoltaic panel series branch according to the desired battery charging voltage of the secondary battery, the current number of series-connected photovoltaic panels of each photovoltaic panel series branch and the current maximum power point voltage, to ensure that the maximum power point voltage of each photovoltaic panel series branch can match the desired battery charging voltage; then upon judging that each photovoltaic panel series branch is currently in the normal condition, controlling the direct charging switch to be turned on to form a charging loop, thereby using the DC current of the photovoltaic panels to directly charge the secondary battery, thereby skipping a conversion process of inverting the direct current into the alternating current and rectifying the alternating current into the direct current, and achieving the purposes of reducing power consumption, improving charging efficiency and reducing hardware cost;
(2) Battery charging may be adapted by using the photovoltaic inverter, so that the battery charging voltage always works at the maximum power point, and the charging efficiency and the utilization rate of photovoltaic power generation amount are effectively improved;
(3) It is possible to achieve the purpose of dynamically adapting the desired battery charging voltage in the charging process, enable the photovoltaic panel series branch to charge the secondary battery at the maximum power point all the time, and ensure a high charging efficiency;
(4) The charging may be automatically terminated during the charging process, and the photovoltaic inverter may be restored from the charging mode to the normal operation mode.
(5) Through specific experimental comparison, when the method for directly charging a battery is applied to charge an automobile battery, the charging efficiency reaches 99%; as compared with a charging station, the method for directly charging a battery may reduce the hardware cost by about 60% since hardware such as a charging module is omitted, thereby helping to effectively advance development of photovoltaic energy storage and new energy automobiles, and facilitating practical application and spreading.

### BRIEF DESCRIPTION OF THE DRAWINGS

In order to more clearly illustrate the embodiments of the disclosure or the technical solutions in the prior art, the drawings in the description of the embodiments or the prior art will be briefly described below. It is obvious that the drawings in the following description only illustrate some embodiments of the disclosure. Those skilled in the art appreciate that other drawings can be obtained according to these drawings without making creative efforts.

FIG. 1 is a schematic flow chart of a method for directly charging a battery based on photovoltaic panels according to the disclosure.

FIG. 2 is a schematic structural diagram of an apparatus for charging a battery based on photovoltaic panels according to the disclosure.

FIG. 3 is a schematic structural diagram of a charging system according to the disclosure.

FIG. 4 is a schematic structural diagram of a control device according to the disclosure.

### DETAILED DESCRIPTION OF THE EMBODIMENTS

In order to more clearly illustrate the embodiments of the disclosure or the technical solutions in the prior art, the disclosure will be briefly described below with reference to the accompanying drawings and the embodiments or the description in the prior art. It is obvious that the following description with reference to the drawings only illustrates some embodiments of the disclosure. Those skilled in the art appreciate that other drawings can also be obtained by those skilled in the art without making creative efforts. It should be noted here that the description of the embodiments is intended to help understand the disclosure, not to be construed as limiting of the disclosure.

It will be understood that, although the terms such as “first”, “second”, etc. may be used herein to describe various objects, these objects should not be limited by these terms. These terms are only used to distinguish one object from another. For example, a first object may be referred to as a second object, and similarly, the second object may be referred to as the first object, without departing from the scope of example embodiments of the disclosure.

It should be understood that, for the term “and/or” as may appear herein, it is merely an associative relationship that describes associated objects, and means that three relationships may exist, e.g., a and/or B may mean three cases: A exists alone, B exists alone, ot A and B co-exist; for the term “/and” as may appear herein, it describes another relationship between associated objects, and may mean that two relationships may exist, e.g., A/and B may mean: A exists alone or A and B co-exist; in addition, for the character “/” that may appear herein, it generally represents that two neighboring associated objects are in an “or” relationship.

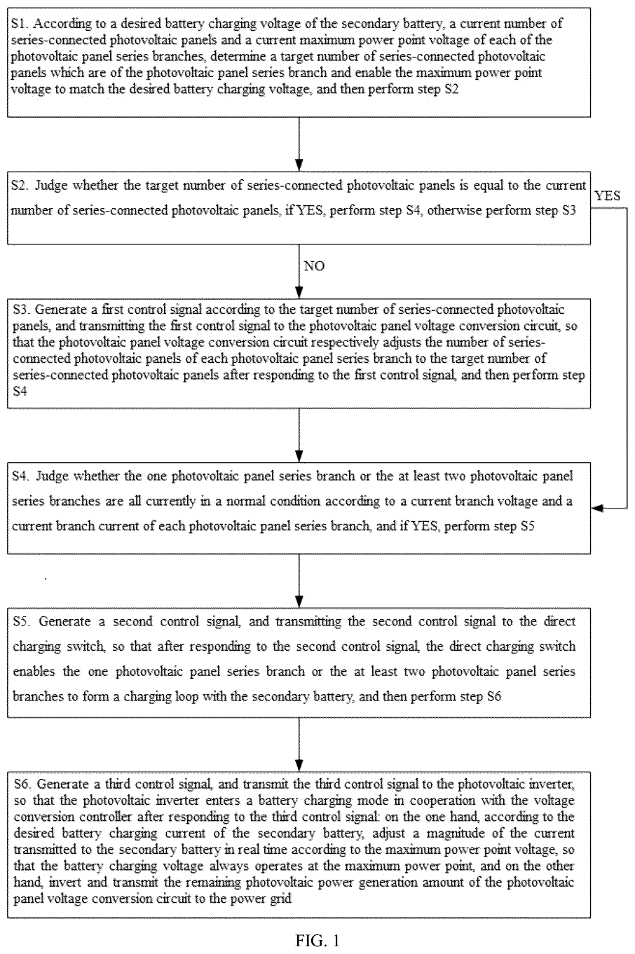

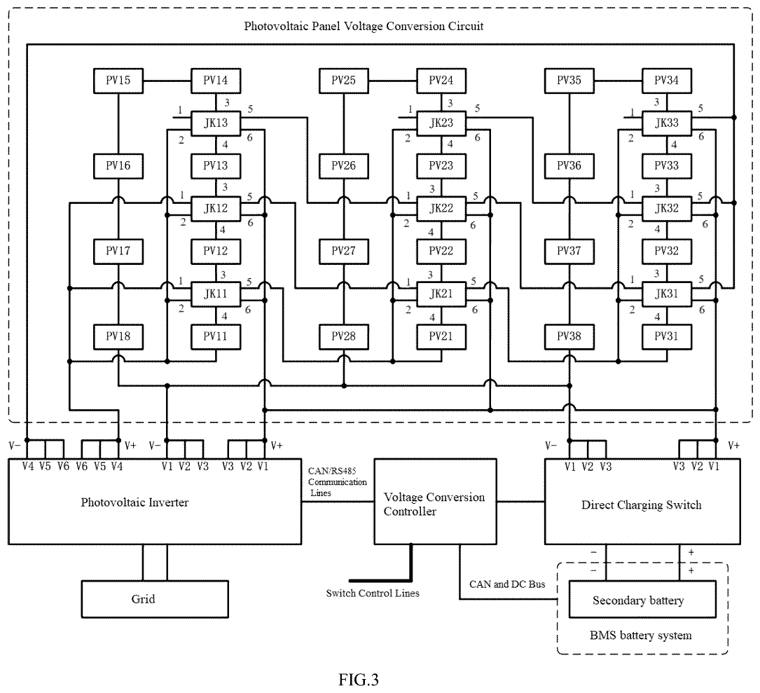

As shown in FIG. 1, a method for directly charging a battery based on photovoltaic panels according to the first aspect of the present embodiment may be, but not limited to be, executed by a voltage conversion controller which is of a charging system and has certain computing resources, for example, executed by a control unit such as a microcontroller, a single chip microcomputer, a Field Programmable Gate Array (FPGA), or a Programmable Logic Controller (PLC). As shown in FIG. 3, the charging system further includes, but is not limited to, a photovoltaic panel voltage conversion circuit, a direct charging switch, and a secondary battery (e.g., an automotive battery, etc.), wherein the photovoltaic panel voltage conversion circuit includes one photovoltaic panel series branch or at least two photovoltaic panel series branches having the same synchronously-adjustable number of series-connected photovoltaic panels, the one photovoltaic panel series branch or each of the at least two photovoltaic panel series branches includes a plurality of series-connected photovoltaic panels having the same property, the voltage converting controller respectively communicatively connects the photovoltaic panel voltage conversion circuit with the direct charging switch, a positive electrode of each photovoltaic panel series branch is electrically connected to a positive input terminal V+ of the direct charging switch, a negative electrode of each photovoltaic panel series branch is electrically connected to a negative input terminal V− of the direct charging switch, the positive output terminal of the direct charging switch is electrically connected to the positive electrode of the secondary battery, and the negative output terminal of the direct charging switch is electrically connected to the negative electrode of the secondary battery. As shown in FIG. 1, the method for directly charging a battery based on photovoltaic panels may include, but is not limited to, the following steps S1 to S5.

S1: according to a desired battery charging voltage of the secondary battery, a current number of series-connected photovoltaic panels and a current maximum power point voltage of each of the photovoltaic panel series branches, determining a target number of series-connected photovoltaic panels which are of the photovoltaic panel series branch and series branchenable the maximum power point voltage to match the desired battery charging voltage, and then executing the step S2.

In the step S1, the desired voltage charging voltage may come from, but not limited to, a BMS (Battery Management System) battery system of the secondary battery; as shown in FIG. 3, the voltage conversion controller is electrically connected to the BMS battery system of the secondary battery through a CAN (Controller Area Network) and a DC (Direct Current) bus, so that the voltage conversion controller may receive battery state data (including but not limited to the desired battery charging voltage, a desired battery charging current, a battery status voltage the secondary battery) from the BMS battery system and then obtain the desired battery charging voltage of the secondary battery from the battery state data. The current number of series-connected photovoltaic panels may be, but not limited to, sensed by a control result of the photovoltaic panel voltage conversion circuit. The current maximum power point voltage may be, but not limited to, the maximum power point voltage of each photovoltaic panel series branch determined in real time through a conventional maximum power point tracking algorithm, and may be an interval value with an upper and lower offset range, for example, [312V,328V]. In addition, a trigger condition of step S1 may be, but not limited to, discovering that the secondary battery needs to be charged according to the battery status voltage or receives a charging request from the BMS battery system status voltage, or the like;

In step S1, the specific process of determining the target number of series-connected photovoltaic panels includes, but not limited to: firstly determining the current maximum power point voltage (which is also an interval value with an upper and lower offset range, such as [38V,42V] of an individual photovoltaic panel according to the current number of series-connected photovoltaic panels and the current maximum power point voltage of each photovoltaic panel series branch, and then determining the target number of series-connected photovoltaic panels which are of the photovoltaic panel series branch and enable the maximum power point voltage to match the desired battery charging voltage according to the desired battery charging voltage of the secondary battery and the current maximum power point voltage of the individual photovoltaic panel. For example, if the desired battery charging voltage of the secondary battery is 240V, and the current maximum power point voltage of the individual photovoltaic panel is [38V,42V], and since 240V belongs to the interval [228V,252V], if the maximum power point voltage of the photovoltaic panel series branch is [228V,252V], it is believed that the maximum power point voltage matches the desired battery charging voltage, and at this time, it may be determined that the target number of series-connected photovoltaic panels is 6. Therefore, the target number of the series-connected photovoltaic panels needed currently can be accurately determined through the construction and application of the voltage linear database (namely, the current maximum power point voltage of an individual photovoltaic panel).

In step S1, specifically, the step of, according to a desired battery charging voltage of the secondary battery, a current number of series-connected photovoltaic panels and a current maximum power point voltage of each of the photovoltaic panel series branches, determining a target number of series-connected photovoltaic panels which are of the photovoltaic panel series branch and enable the maximum power point voltage to match the desired battery charging voltage includes but not limited to: judging whether the secondary battery can be charged according to the maximum power point voltage of each photovoltaic panel series branch as recorded in the latest unit time period; if YES, determining the target number of series-connected photovoltaic panels which are of the photovoltaic panel series branch and enable the maximum power point voltage to match the desired battery charging voltage, according to the desired battery charging voltage of the secondary battery, the current number of series-connected photovoltaic panels and the current maximum power point voltage of each of the photovoltaic panel series branches, otherwise series branch triggering to generate and display reminding information indicating that the secondary battery is not chargeable currently. Specifically, the latest unit time period may be, but not limited to, the latest 1 minute, the latest 3 minutes, the latest 10 minutes, or the like. Since the maximum power point voltage of each photovoltaic panel series branch as recorded in the latest unit time interval can reflect the latest weather change conditions (such as the ambient temperature, the illuminance and the like), if it is discovered that in the latest unit time interval there are severe or violent weather changes, it is determined that the battery is not adapted to be charged. For example, the maximum power point voltage is generally low on cloudy days, the maximum power point voltage cannot match the desired battery charging voltage even though the number of series-connected photovoltaic panels is adjusted to a maximum value, whereupon the secondary battery is not adapted to be directly charged, and the reminding information is triggered to be generated and displayed.

S2: judging whether the target number of series-connected photovoltaic panels is equal to the current number of series-connected photovoltaic panels, if YES, executing step S4, otherwise, executing step S3.

In the step S2, for example, if the target number of series-connected photovoltaic panels is 6 and the current number of series-connected photovoltaic panels is also 6, it is not necessary to adjust the number of series-connected photovoltaic panels of each of the photovoltaic panel series branches, and the process may jump to step S3, otherwise performing step S3 to adjust the number of series-connected photovoltaic panels of each of the photovoltaic panel series branches.

S3: generating a first control signal according to the target number of series-connected photovoltaic panels, and transmitting the first control signal to the photovoltaic panel voltage conversion circuit, so that the photovoltaic panel voltage conversion circuit respectively adjusts the number of series-connected photovoltaic panel of each photovoltaic panel series branch to the target number of series-connected photovoltaic panels after responding to the first control signal, and then executing step S4.

In the step S3, in order to specifically realize the purpose of adjusting the number of series-connected photovoltaic panels, preferably when the charging system further includes a photovoltaic inverter, the photovoltaic panel voltage conversion circuit includes, but not limited to, K photovoltaic panel series branches, where the photovoltaic panel series branches include N photovoltaic panels serially connected in sequence in a direction from a positive electrode to a negative electrode dand M switches arranged in sequence in the direction from the positive electrode to the negative electrode direction, an m^{th} switch among the M switches in the direction from the positive electrode to the negative electrode is a first switch, an M^{th} switch among the M switches in the direction from the positive electrode to the negative electrode is a second switch, K represents a positive integer, M represents a positive integer not less than 2, and M represents a positive integer less than M; the first switcher includes pin #1, pin #2, pin #3, pin #4, pin #5 and pin #6, where when the first switch is in a first state, only pin #3 is electrically connected with pin #4 and pin #2 is electrically connected with pin #6; when the first switch is in a second state, only pin #1 is electrically connected with pin #2 and pin #3 respectively, and pin #4 is electrically connected with pin #5; the second switch includes pin #2, pin #3, pin #4, pin #5 and pin #6, wherein when the second switcher is in the first state, only pin #3 is electrically connected with pin #4 and pin #2 is electrically connected with pin #6; when the second switcher is in the second state, only pin #3 is electrically connected with pin #6 and pin #4 is electrically connected with pin #5; the positive electrode of the (M+1)^{th} photovoltaic panel among the N photovoltaic panels in the direction from the positive electrode to the negative electrode is electrically connected with pin #3 of the M^{th} switch, the negative electrode of the M^{th} photovoltaic panel among the N photovoltaic panels in the direction from the positive electrode to the negative electrode is electrically connected to pin #4 of the M^{th} switch, the positive electrode of the (m+1)^{th} photovoltaic panel among the N photovoltaic panels in the direction from the positive electrode to the negative electrode is electrically connected to pin #3 of the m^{th} switch, and the negative electrode of the m^{th} photovoltaic panel among the N photovoltaic panels in the direction from the positive electrode to the negative electrode is electrically connected to pin #4 of the m^{th} switch; for the first photovoltaic panel series branch of K photovoltaic panel series branches, the corresponding pin #1 of the m^{th} switch, the corresponding pins #2 of the M switches and the corresponding positive electrode of the first photovoltaic panel in the direction from the positive electrode to the negative electrode are respectively electrically connected to a positive electrode input terminal V+ of the photovoltaic inverter, and the corresponding pins #6 of the M switches are respectively electrically connected to the positive electrode input terminal V+ of the photovoltaic inverter; for the k^{th} photovoltaic panel series branch in the K photovoltaic panel series branches, the corresponding pins #2 of the corresponding M switches and the positive electrode of the corresponding first photovoltaic panel in the direction from the positive electrode to the negative electrode are respectively electrically connected to pin #5 of the first switch in the (k−1)^{th} photovoltaic panel series branch in the direction from the positive electrode to the negative electrode, and pin #1 of the corresponding w^{th} switch in the direction from the positive electrode to the negative electrode is electrically connected to pin #5 of the (w+1)^{th} switch in the (k−1)^{th} photovoltaic panel series branch in the direction from the positive electrode to the negative electrode; the corresponding pins #6 of the M switches are respectively electrically connected to the positive electrode input terminal V+ of the photovoltaic inverter, wherein k is a positive integer greater than 1 and not greater than K, and w is a positive integer greater than 1 and not greater than M; for the K^{th} photovoltaic panel series branch of the K photovoltaic panel series branches, the corresponding pins #5 of the M switches are respectively electrically connected to a negative electrode input terminal V− of the photovoltaic inverter; the x^{th} switch in each of the photovoltaic panel series branches in the direction from the positive electrode to the negative electrode is synchronously controlled by the voltage conversion controller; furthermore, when the x^{th} switch is in the first state, only the y^{th} switch in the direction from the positive electrode to the negative electrode can be in the second state, wherein x is a positive integer no greater than M, and y is a positive integer less than x. In this way, by means of the arrangement design of the above-mentioned photovoltaic panels and switches (which may specifically be, but not limited to, a contactor having a multi-pin terminal), not only the number of series-connected photovoltaic panels of each of said photovoltaic panel series branches can be arbitrarily adjusted in the interval [N−M, N], but also a plurality of photovoltaic panels switched off can be recombined into at least one new photovoltaic panel series branch (each of said new photovoltaic panel series branches respectively comprises K photovoltaic panels serially connected in sequence in the direction from the positive electrode to the negative electrode), and the positive and negative electrodes of each of the new photovoltaic panel series branches are also butted to the positive and negative electrode input terminals of said photovoltaic inverter; so as to transfer all the photovoltaic power generation amount inversions of the at least one new photovoltaic panel series branch to the power grid (namely, being realized by the photovoltaic inverter), thereby ensuring that all the photovoltaic panels are always working.

As shown in FIG. 3, for example, the photovoltaic panel voltage conversion circuit includes 3 photovoltaic panel series branches, where each photovoltaic panel series branch includes 8 photovoltaic panels connected in series in sequence from the positive electrode to the negative electrode and 3 switches arranged in sequence from the positive electrode to the negative electrode, that is, for a first photovoltaic panel series branch on the left side, corresponding 8 photovoltaic panels are PV11 to PV18 respectively, and corresponding 3 switches are JK11 to JK13 respectively, where JK11 and JK12 are respectively first switches, and JK13 is a second switch; for the middle second photovoltaic panel series branch, the corresponding 8 photovoltaic panels are PV 21-PV 28 respectively, and the corresponding 3 switches are JK 21-JK 23 respectively, wherein JK21 and JK22 are respectively first switches, and JK23 is a second switch; for the third photovoltaic panel series branch on the right side, the corresponding 8 photovoltaic panels are PV 31-PV 38 respectively, and the corresponding 3 switches are JK 31-JK 33 respectively, wherein JK31 and JK32 are respectively first switches, and JK33 is a second switch; meanwhile, JK 11-JK 31 are a first switch group synchronously controlled by the voltage conversion controller; JK 12-JK 32 are a second switch group synchronously controlled by the voltage conversion controller; JK 13-JK 33 are a third switch group synchronously controlled by the voltage conversion controller; when the second switch group is synchronically in the first state, only the first switch can be synchronically in the second state; when the third switch group is synchronously in the first state, only the second switch group and the first switch group can be synchronously in the second state, so that the number of series-connected photovoltaic panels of each of the photovoltaic panel series branches can be arbitrarily adjusted in an interval [5,8]. Meanwhile, if the target number of series-connected photovoltaic panels is 6, the first control signal may be generated for enabling the second switch group and the first switch group to be in the second state and enabling the third switch group to be in the first state and then the first control signal is transmitted to each switch in the photovoltaic panel voltage conversion circuit through a switch control line, so that after each switch responds to the first control signal, the number of series-connected photovoltaic panels of each of the photovoltaic panel series branches is respectively adjusted to 6 (namely, PV 13 to PV 18 are sequentially connected in series for the first photovoltaic panel series branch on the left side; PV23 to PV28 are sequentially connected in series for the second photovoltaic panel series branch in the middle; PV33 to PV38 are sequentially connected in series for the third photovoltaic panel series branch on the right side); meanwhile, photovoltaic panels PV 11-PV 31 form a first new photovoltaic panel series branch, and photovoltaic panels PV 12-PV 32 form a second new photovoltaic panel series branch, so that two new photovoltaic panel series branches which are connected in parallel and whose positive electrode and negative electrode are also butted with the positive and negative input terminals of the photovoltaic inverter are obtained, such that all photovoltaic power generation amount of the two new photovoltaic panel series branches is inverted and transmitted to the power grid.

S4: judging whether the one photovoltaic panel series branch or the at least two photovoltaic panel series branches are all currently in a normal condition according to a current branch voltage and a current branch current of each photovoltaic panel series branch, and if YES, executing step S5.

In the step S4, a specific judging manner is a conventional judging manner. For example, if it is found that the current branch voltage and/or the current branch current of a certain photovoltaic panel series branch exceeds a preset corresponding threshold or is lower than another preset corresponding threshold, the certain photovoltaic panel series branch is considered to be in an abnormal condition, and a fault problem is diagnosed. In addition, after judging whether the one photovoltaic panel series branch or the at least two photovoltaic panel series branches are both in a normal condition, the method further includes, but not limited to: if the photovoltaic panel series branch or any of the at least two photovoltaic panel series branches is judged currently in the abnormal condition, triggering to generate and display reminding information indicating that the battery cannot be charged currently, wherein the reminding information may include but not limited to content such as a fault problem determined by diagnosis, the current branch voltage value and the current branch current value of the photovoltaic panel series branch in the abnormal condition.

=S5: generating a second control signal, and transmitting the second control signal to the direct charging switch, so that after responding to the second control signal, the direct charging switch enables the one photovoltaic panel series branch or the at least two photovoltaic panel series branches to form a charging loop with the secondary battery.

In step S5, specifically, the second control signal is a control signal for controlling the conduction of the direct charging switch.

Therefore, based on the method for directly charging a battery based on the photovoltaic panels described in the foregoing steps S1 to S5, there is provided a new solution for charging the secondary battery by using the direct current of the photovoltaic panels, that is, the number of series-connected photovoltaic panels of each photovoltaic panel series branch is adjusted according to the desired battery charging voltage of the secondary battery, the current number of series-connected photovoltaic panels of each photovoltaic panel series branch and the current maximum power point voltage, to ensure that the maximum power point voltage of each photovoltaic panel series branch can match the desired battery charging voltage; then when it is judged that each photovoltaic panel series branch is currently in the normal condition, the direct charging switch is controlled to be turned on to form a charging loop, and the photovoltaic inverter is controlled to enter a battery charging mode, so that the secondary battery can be directly charged by using the direct current of the photovoltaic panels, thereby skipping a conversion process of inverting the direct current into the alternating current and rectifying the alternating current into the direct current, and achieving the purposes of reducing power consumption, improving charging efficiency and reducing hardware cost.

In the present embodiment, on the basis of the technical solution of the first aspect, a first possible design of how to adapt battery charging is further provided, that is, the method for directly charging a battery further includes the following step S6 after step S5 when the charging system further includes a photovoltaic inverter and a power grid, the voltage conversion controller is further communicatively connected to the photovoltaic inverter, the positive electrodes of the photovoltaic panel series branches are further electrically connected to the positive input terminal of the photovoltaic inverter, respectively, the negative electrodes of the photovoltaic panel series branches are further electrically connected to the negative input terminal of the photovoltaic inverter, and the alternating current output terminal of the photovoltaic inverter is electrically connected to the power grid.

S6: generating a third control signal, and transmitting the third control signal to the photovoltaic inverter, so that the photovoltaic inverter enters a battery charging mode in cooperation with the voltage conversion controller after responding to the third control signal: on the one hand, according to the desired battery charging current of the secondary battery, adjusting a magnitude of the current transmitted to the secondary battery in real time according to the maximum power point voltage, so that the battery charging voltage always operates at the maximum power point, and on the other hand, inverting and transmitting the remaining photovoltaic power generation amount of the photovoltaic panel voltage conversion circuit to the power grid.

In step S6, as shown in FIG. 3, the voltage conversion controller is electrically connected to the photovoltaic inverter through the CAN/RS485 communication line, so that the voltage conversion controller may receive inverter status data (including but not limited to content such as the operating mode of the photovoltaic inverter and the current maximum power point voltage, the current branch voltage, and the current branch current of each photovoltaic panel series branch) from the photovoltaic inverter, and then obtain the current maximum power point voltage of each photovoltaic panel series branch from the inverter status data. The desired battery charging current may also come from, but not limited to, a BMS (Battery Management System) battery system of the secondary battery, and be acquired in real time from the battery status data received in real time. A specific manner of adjusting the current magnitude by the photovoltaic inverter in cooperation with the voltage conversion controller is an existing conventional manner, for example, controlling a duty cycle of a PWM (Pulse Width Modulation) signal according to the desired battery charging current, thereby achieving the purpose of adjusting the current magnitude. The remaining photovoltaic power generation amount specifically includes the photovoltaic power generation amount of the one photovoltaic panel series branch or the at least two photovoltaic panel series branches, which is not yet transmitted to the secondary battery, and the total photovoltaic power generation amount of the at least one new photovoltaic panel series branch (if any). In addition, the specific manner of the photovoltaic inverter inverting and transmitting the remaining photovoltaic power generation amount of the photovoltaic panel voltage conversion circuit to the power grid is the essential work of the photovoltaic inverter, and is not described in detail herein again.

Therefore, based on the first possible design, battery charging may be adapted by using the photovoltaic inverter, so that the battery charging voltage always works at the maximum power point, and the charging efficiency and the utilization rate of photovoltaic power generation amount are effectively improved. In addition, battery charging may also be adapted by using a DC-DC buck-boost circuit, so that the battery charging voltage always works at the maximum power point, and the charging efficiency and the utilization rate of photovoltaic power generation amount are effectively improved, i.e., the method for directly charging a battery further comprise the following step after step S5 when the charging system further comprises a DC-DC buck-boost circuit, the voltage conversion controller is also communicatively connected to said DC-DC buck-boost circuit, and the positive electrodes of the photovoltaic panel series branches are also respectively electrically connected to a positive electrode input terminal of said DC-DC buck-boost circuit, the negative electrodes of the photovoltaic panel series branch are also respectively electrically connected to a negative electrode input terminal of the DC-DC buck-boost circuit, the positive electrode output terminal of the DC-DC buck-boost circuit is electrically connected to the positive electrode of the secondary battery, and the negative electrode output terminal of the DC-DC buck-boost circuit is electrically connected to the negative electrode of the secondary battery: generating an eighth control signal and transmitting the eighth control signal to the DC-DC buck-boost circuit, so that the DC-DC buck-boost circuit enters a battery charging mode in cooperation with the voltage conversion controller after responding to the eighth control signal: on the one hand, according to the desired battery charging current of the secondary battery, adjusting a magnitude of the current transmitted to the secondary battery in real time according to the maximum power point voltage, so that the battery charging voltage always operates at the maximum power point; and on the other hand, transmitting the remaining photovoltaic power generation amount of the photovoltaic panel voltage conversion circuit to the secondary battery after bucking or boosting the voltage via the DC-DC buck-boost circuit. A specific circuit configuration of the DC-DC buck-boost circuit may be implemented with reference to a conventional voltage buck-boost circuit.

Based on the above technical solution of the first possible design, the present embodiment further provides a second possible design about how to dynamically adapt the desired battery charging voltage during the charging process, that is, after step S6 is executed, the method further includes, but not limited to, the following steps S711 to S714.

S711: judging whether the desired battery charging voltage of the secondary battery matches the current maximum power point voltage of each photovoltaic panel series branch, and if NO, executing step S712.

In step S711, for example, if the desired battery charging voltage is 240V, the current maximum power point voltage of each photovoltaic panel series branch is reduced to about 180V due to changes of factors such as the ambient temperature and the illuminance, whereupon no matching may be judged, and it is necessary to adjust and increase the number of number of series-connected photovoltaic panels (for example, from 6 to 8) of each photovoltaic panel series branch to increase the maximum power point voltage.

S712: adjusting to reduce the current magnitude until the current magnitude is not larger than a preset current threshold, and executing step S713.

In said step S712, the current magnitude may be adjusted and reduced by a conventional cooperation between the photovoltaic inverter and the voltage conversion controller, to stop inputting the electricity quantity to the secondary battery.

S713: generating a fourth control signal, transmitting the fourth control signal to the direct charging switch, so that the direct charging switch cuts off the charging loop after responding to the fourth control signal, and then executing step S714.

In said step S713, specifically, the fourth control signal is a control signal for controlling the direct charging switch to be turned off.

S714: returning to execute steps S1 to S6.

Therefore, based on the second possible design, it is possible to achieve the purpose of dynamically adapting the desired battery charging voltage in the charging process, enable the photovoltaic panel series branch to charge the secondary battery at the maximum power point all the time, and ensure a high charging efficiency.

On the basis of the technical solution of the first possible design, the present embodiment further provides a third possible design about how to automatically terminate charging in the charging process, that is, after step S6 is executed, the method further includes, but not limited to, the following steps S721 to S726.

S721: if it is found according to the battery status data of the secondary battery that the charging of the secondary battery needs to be stopped, executing step S722.

In the step S721, for example, if it is found according to the battery status data of the secondary battery that the battery is charged full or the battery status voltage is constantly equal to/greater than the maximum power point voltage of each of the photovoltaic panel series branches, it may be determined that the charging of the secondary battery needs to be stopped.

S722: executing step S723 after the adjusting to reduce the current magnitude until the current magnitude is not larger than the preset current threshold.

S723: generating a fourth control signal, transmitting the fourth control signal to the direct charging switch, so that the direct charging switch cuts off the charging loop after responding to the fourth control signal, and then executing step S724.

S724: judging whether the current number of series-connected photovoltaic panels of each of the photovoltaic panel series branches is equal to a maximum adjustable integer value, if YES, executing step S726, and otherwise, executing step S725.

In said step S724, as shown in FIG. 3, for example, the maximum adjustable integer value is 8.

S725: generating a fifth control signal, and transmitting the fifth control signal to the photovoltaic panel voltage conversion circuit, so that the photovoltaic panel voltage conversion circuit respectively adjusts the number of series-connected photovoltaic panels of each of the photovoltaic panel series branches to the maximum adjustable integer value after responding to the fifth control signal, and then executing step S726.

In said step S725, as shown in FIG. 3, for example, the fifth control signal is a control signal for enabling the first switch group, the second switch group and the third switch group to be in the first state respectively.

S726: generating a sixth control signal, and transmitting the sixth control signal to the photovoltaic inverter, so that the photovoltaic inverter, after responding to the sixth control signal, enters a normal working mode: inverting and transmitting all the photovoltaic power generation amount of the photovoltaic panel voltage conversion circuit to the power grid.

In the step S726, since the numbers of the series-connected photovoltaic panels of the photovoltaic panel series branches have been respectively adjusted to the maximum adjustable integer value, no new photovoltaic panel series branch is generated, and all the photovoltaic power generation amount of the photovoltaic panel voltage conversion circuit is also all the photovoltaic power generation amount of the at least two photovoltaic panel series branches.

Therefore, based on the above third possible design, the charging may be automatically terminated during the charging process, and the photovoltaic inverter may be restored from the charging mode to the normal operation mode.

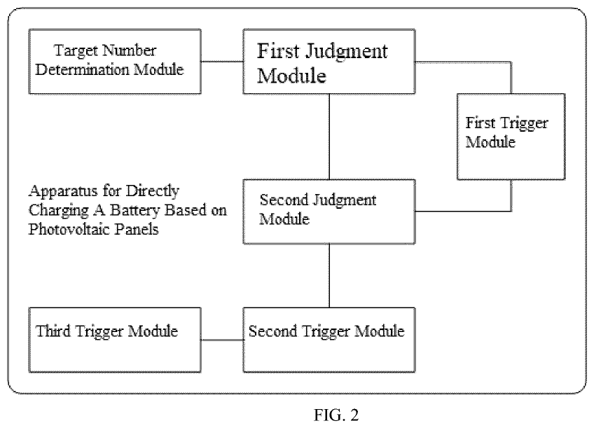

In addition, when the energy storage battery is charged, the electricity amount transmitted to the power grid may be adjusted on demand of the power grid for electricity. That is, in order to perform the function of supplying power to the power grid by using the secondary battery, the method may further comprise generating a seventh control signal, transmitting the seventh control signal to a direct current switch whose both ends are respectively and electrically connected with the secondary battery and the photovoltaic inverter, so that the direct current switch, after responding to the seventh control signal, conducts a power supply path between the secondary battery and the photovoltaic inverter, whereupon the photovoltaic inverter may invert and transmit the stored electricity amount of the secondary battery to the power grid, and thereby use the electricity storage function of the secondary battery to achieve the purposes of storing redundant electric energy in the day with sufficient illumination and supplying power to the power grid in rainy days or at night, thereby functioning for peak load shifting for the power grid. As shown in FIG. 2, a second aspect of the present embodiment provides a virtual device for implementing the method for directly charging a battery according to the first aspect or any of possible designs of the first aspect, the virtual device being adapted to be disposed in a voltage conversion controller of a charging system, wherein the charging system further includes a photovoltaic panel voltage conversion circuit, a direct charging switch and a secondary battery, where the photovoltaic panel voltage conversion circuit includes one photovoltaic panel series branch or at least two photovoltaic panel series branches having the same synchronously-adjustable number of series-connected photovoltaic panels, each of the one photovoltaic panel series branch or the at least two photovoltaic panel series branches comprises a plurality of series-connected photovoltaic panels having the same property, the voltage conversion controller respectively communicatively connects the photovoltaic panel voltage conversion circuit and the direct charging switch, a positive electrode of each photovoltaic panel series branch is electrically connected to a positive input terminal of the direct charging switch, a negative electrode of each photovoltaic panel series branch is electrically connected to a negative input terminal of the direct charging switch, the positive output terminal of the direct charging switch is electrically connected to the positive electrode of the secondary battery, and the negative output terminal of the direct charging switch is electrically connected to the negative electrode of the secondary battery; the virtual device comprises a target number determination module, a first judgment module, a first trigger module, a second judgment module and a second trigger module;
the target number determination module is communicatively connected to the first judgment module and configured to, according to a desired battery charging voltage of the secondary battery, a current number of series-connected photovoltaic panels and a current maximum power point voltage of each of the photovoltaic panel series branches, determine a target number of series-connected photovoltaic panels which are of the photovoltaic panel series branch and enable the maximum power point voltage to match the desired battery charging voltage, and then activate the first judgment module;
the first judgment module is communicatively connected with the first trigger module and the second judgment module, respectively, and configured to judge whether the target number of series-connected photovoltaic panels is equal to the current number of series-connected photovoltaic panels, if YES, activate the second judgment module, otherwise, activate the first trigger module;
the first trigger module is communicatively connected with the second judgment module and configured to generate a first control signal according to the target number of series-connected photovoltaic panels, and transmit the first control signal to the photovoltaic panel voltage conversion circuit, so that the photovoltaic panel voltage conversion circuit respectively adjusts the number of series-connected photovoltaic panels of each photovoltaic panel series branch to the target number of series-connected photovoltaic panels after responding to the first control signal, and then activate the second judgment module;
the second judgment module is communicatively connected with the second trigger module and configured to judge whether the one photovoltaic panel series branch or the at least two photovoltaic panel series branches are all currently in a normal condition according to a current branch voltage and a current branch current of each photovoltaic panel series branch, and if YES, activate the second trigger module;
the second trigger module is configured to generate a second control signal, and transmit the second control signal to the direct charging switch, so that after responding to the second control signal, the direct charging switch enables the one photovoltaic panel series branch or the at least two photovoltaic panel series branches to form a charging loop with the secondary battery.

In a possible design, when the charging system further comprises a photovoltaic inverter and a power grid, and the voltage conversion controller is further communicatively connected to the photovoltaic inverter, the positive electrodes of the photovoltaic panel series branches are further respectively electrically connected to the positive input terminal of the photovoltaic inverter, and the negative electrodes of the photovoltaic panel series branches are further respectively electrically connected to the negative input terminal of the photovoltaic inverter; and an AC output terminal of the photovoltaic inverter is electrically connected to the power grid, the virtual device further includes a third trigger module communicatively connected to the second trigger module;
the third trigger module is configured to, after the second control signal is transmitted to the direct charging switch, trigger to generate a third control signal, and transmit the third control signal to the photovoltaic inverter, so that the photovoltaic inverter enters a battery charging mode in cooperation with the voltage conversion controller after responding to the third control signal: on the one hand, according to the desired battery charging current of the secondary battery, adjust a magnitude of the current transmitted to the secondary battery in real time according to the maximum power point voltage, so that the battery charging voltage always operates at the maximum power point, and on the other hand, invert and transmit the remaining photovoltaic power generation amount of the photovoltaic panel voltage conversion circuit to the power grid.

For the working process, the working details and the technical effects of the foregoing device according to the second aspect of the present embodiment, reference may be made to the method for directly charging a battery according to the first aspect or any of possible designs in the first aspect, and details are not described in detail any more herein.

As shown in FIG. 3, a third aspect of the present embodiment provides a charging system for implementing the method for directly charging a battery according to the first aspect or any of possible designs in the first aspect, comprising a voltage conversion controller of a charging system, wherein the charging system further includes a photovoltaic panel voltage conversion circuit, a direct charging switch and a secondary battery, wherein the photovoltaic panel voltage conversion circuit includes one photovoltaic panel series branch or at least two photovoltaic panel series branches having the same synchronously-adjustable number of series-connected photovoltaic panels, each of the one photovoltaic panel series branch or the at least two photovoltaic panel series branches comprises a plurality of series-connected photovoltaic panels having the same property, the voltage conversion controller respectively communicatively connects the photovoltaic panel voltage conversion circuit and the direct charging switch, a positive electrode of each photovoltaic panel series branch is electrically connected to a positive input terminal of the direct charging switch, a negative electrode of each photovoltaic panel series branch is electrically connected to a negative input terminal of the direct charging switch, the positive output terminal of the direct charging switch is electrically connected to the positive electrode of the secondary battery, and the negative output terminal of the direct charging switch is electrically connected to the negative electrode of the secondary battery; the voltage conversion controller is configured to perform the method for directly charging a battery according to the first aspect or any one of the possible designs of the first aspect.

In one possible design, when the charging system further comprises a photovoltaic inverter, the photovoltaic panel voltage conversion circuit includes K said photovoltaic panel series branches, where the photovoltaic panel series branches include N photovoltaic panels serially connected in sequence in a direction from a positive electrode to a negative electrode and M switches arranged in sequence in the direction from the positive electrode to the negative electrode direction, an m^{th} switch among the M switches in the direction from the positive electrode to the negative electrode is a first switch, an M^{th} switch among the M switches in the direction from the positive electrode to the negative electrode is a second switch, K represents a positive integer, M represents a positive integer not less than 2, and M represents a positive integer less than M;
the first switcher includes pin #1, pin #2, pin #3, pin #4, pin #5 and pin #6, where when the first switch is in a first state, only pin #3 is electrically connected with pin #4 and pin #2 is electrically connected with pin #6; when the first switch is in a second state, only pin #1 is electrically connected with pin #2 and pin #3 respectively, and pin #4 is electrically connected with pin #5;
the second switch includes pin #2, pin #3, pin #4, pin #5 and pin #6, wherein when the second switcher is in the first state, only pin #3 is electrically connected with pin #4 and pin #2 is electrically connected with pin #6; when the second switcher is in the second state, only pin #3 is electrically connected with pin #6 and pin #4 is electrically connected with pin #5;
the positive electrode of the (M+1)^{th} photovoltaic panel among the N photovoltaic panels in the direction from the positive electrode to the negative electrode is electrically connected with pin #3 of the M^{th} switch, the negative electrode of the M^{th} photovoltaic panel among the N photovoltaic panels in the direction from the positive electrode to the negative electrode is electrically connected to pin #4 of the M^{th} switch, the positive electrode of the (m+1)^{th} photovoltaic panel among the N photovoltaic panels in the direction from the positive electrode to the negative electrode is electrically connected to pin #3 of the m^{th} switch, and the negative electrode of the m^{th} photovoltaic panel among the N photovoltaic panels in the direction from the positive electrode to the negative electrode is electrically connected to pin #4 of the m^{th} switch;
for the first photovoltaic panel series branch of the K photovoltaic panel series branches, the corresponding pin #1 of the m^{th} switch, the corresponding pins #2 of the M switches and the corresponding positive electrode of the first photovoltaic panel in the direction from the positive electrode to the negative electrode are respectively electrically connected to a positive electrode input terminal V+ of the photovoltaic inverter, and the corresponding pins #6 of the M switches are respectively electrically connected to the positive electrode input terminal V+ of the photovoltaic inverter;
for the k^{th} photovoltaic panel series branch in the K photovoltaic panel series branches, the corresponding pins #2 of the corresponding M switches and the positive electrode of the corresponding first photovoltaic panel in the direction from the positive electrode to the negative electrode are respectively electrically connected to pin #5 of the first switch in the (k−1)^{th} photovoltaic panel series branch in the direction from the positive electrode to the negative electrode, and pin #1 of the corresponding w^{th} switch in the direction from the positive electrode to the negative electrode is electrically connected to pin #5 of the (w+1)^{th} switch in the (k−1)^{th} photovoltaic panel series branch in the direction from the positive electrode to the negative electrode; the corresponding pins #6 of the M switches are respectively electrically connected to the positive electrode input terminal V+ of the photovoltaic inverter, wherein k is a positive integer greater than 1 and not greater than K, and w is a positive integer greater than 1 and not greater than M;
for the K^{th} photovoltaic panel series branch of the K photovoltaic panel series branches, the corresponding pins #5 of the M switches are respectively electrically connected to a negative electrode input terminal V− of the photovoltaic inverter;
the x^{th} switch in each of the photovoltaic panel series branches in the direction from the positive electrode to the negative electrode is synchronously controlled by the voltage conversion controller; furthermore, when the x^{th} switch is in the first state, only the y^{th} switch in the direction from the positive electrode to the negative electrode can be in the second state, wherein x is a positive integer no greater than M, and y is a positive integer less than x.

For the working process, the working details and the technical effects of the foregoing system according to the third aspect of the present embodiment, reference may be made to the method for directly charging a battery according to the first aspect or any of possible designs in the first aspect, and details are not described in detail any more herein.

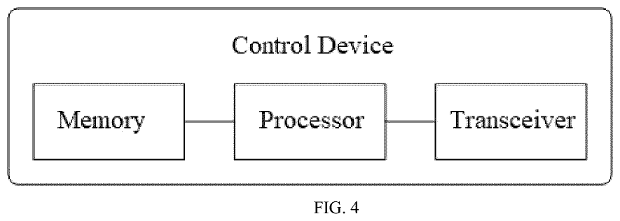

As shown in FIG. 4, a fourth aspect of the present embodiment provides a control device for implementing the method for directly charging a battery according to the first aspect or any of the possible designs of the first aspect, including a memory, a processor and a transceiver which are sequentially and communicatively connected, wherein the memory is used to store a computer program, the transceiver is used to transmit and receive a message, and the processor is used to read the computer program and execute the method for directly charging a battery according to the first aspect or any of the possible designs of the first aspect. For example, the memory may include, but not limited to, a Random-Access Memory (RAM), a Read-Only Memory (ROM), a Flash Memory (Flash Memory), a First-in First-out (FIFO), and/or a First-in Last-out (FILO), and the like; the processor may employ, but not limited to, a microprocessor of the model number STM32F105 series. In addition, the control device may also include, but not limited to, a power supply module, a display screen, and other necessary components.

For the working process, the working details and the technical effects of the foregoing control device according to the fourth aspect of the present embodiment, reference may be made to the method for directly charging a battery according to the first aspect or any of possible designs in the first aspect, and details are not described in detail any more herein.

A fifth aspect of the present embodiment provides a computer-readable storage medium storing instructions including the method for directly charging a battery according to the first aspect or any of possible designs in the first aspect, that is, the computer-readable storage medium storing instructions that, when executed on a computer, perform the method for directly charging a battery according to the first aspect or any of possible designs in the first aspect. The computer-readable storage medium refers to a carrier for storing data, and may include, but not limited to, a computer-readable storage medium such as a floppy disk, an optical disk, a hard disk, a flash memory, a USB flash disk and/or a Memory Stick, and the computer may be a general-purpose computer, a special-purpose computer, a computer network, or other programmable devices.

For the working process, the working details and the technical effects of the foregoing computer-readable storage medium according to the fifth aspect of the present embodiment, reference may be made to the method for directly charging a battery according to the first aspect or any of possible designs in the first aspect, and details are not described in detail any more herein.

A sixth aspect of the present embodiments provides a computer program product comprising instructions which, when run on a computer, cause the computer to implement the method for directly charging a battery according to the first aspect or any of possible designs in the first aspect. The computer may be a general-purpose computer, a special-purpose computer, a computer network, or other programmable devices.

Finally, it should be appreciated that what are described above are only preferred embodiments of the disclosure, and are not intended to limit the scope of the disclosure. Any modifications, equivalent substitutions, or improvements made within the spirit and principle of the disclosure should be included in the protection scope of the disclosure.

What is claimed is:

1. A method for directly charging a battery based on photovoltaic panels, wherein the method is executed by a voltage conversion controller of a charging system, wherein the charging system further comprises a photovoltaic panel voltage conversion circuit, a direct charging switch and a secondary battery, where the photovoltaic panel voltage conversion circuit includes one photovoltaic panel series branch or at least two photovoltaic panel series branches, the one photovoltaic panel series branch or each of the at least two photovoltaic panel series branches comprises a plurality of series-connected photovoltaic panels; the photovoltaic voltage conversion circuit synchronously adjusts a number of series-connected photovoltaic panels of all the photovoltaic panel series branch and meanwhile re-combine the adjusted plurality of photovoltaic panels into at least one new photovoltaic panel series branch to charge the secondary battery or transmit electricity to the external, or the photovoltaic voltage conversion circuit only selects one of the photovoltaic panel series branches to charge the secondary battery and transmits the electricity on remaining photovoltaic panel series branches to the external; the voltage conversion controller respectively communicatively connects the photovoltaic panel voltage conversion circuit and the direct charging switch, a positive electrode of each photovoltaic panel series branch is electrically connected to a positive input terminal of the direct charging switch, a negative electrode of each photovoltaic panel series branch is electrically connected to a negative input terminal of the direct charging switch, the positive output terminal of the direct charging switch is electrically connected to the positive electrode of the secondary battery, and the negative output terminal of the direct charging switch is electrically connected to the negative electrode of the secondary battery;
the method for directly charging a battery comprises the following steps S1-D5:
S1: according to a desired battery charging voltage of the secondary battery, a current number of series-connected photovoltaic panels and a current maximum power point voltage of each of the photovoltaic panel series branches, determining a target number of series-connected photovoltaic panels which are of the photovoltaic panel series branch and enable the maximum power point voltage to match the desired battery charging voltage, and then performing step S2;
S2: judging whether the target number of series-connected photovoltaic panels is equal to the current number of series-connected photovoltaic panels, if YES, performing step S4, otherwise performing step S3;
S3: generating a first control signal according to the target number of series-connected photovoltaic panels, and transmitting the first control signal to the photovoltaic panel voltage conversion circuit, so that the photovoltaic panel voltage conversion circuit respectively adjusts the number of series-connected photovoltaic panels of each photovoltaic panel series branch to the target number of series-connected photovoltaic panels after responding to the first control signal, and then performing step S4;
S4: judging whether the one photovoltaic panel series branch or the at least two photovoltaic panel series branches are all currently in a normal condition according to a current branch voltage and a current branch current of each photovoltaic panel series branch, and if YES, performing step S5;
S5: generating a second control signal, and transmitting the second control signal to the direct charging switch, so that after responding to the second control signal, the direct charging switch enables the one photovoltaic panel series branch or the at least two photovoltaic panel series branches to form a charging loop with the secondary battery.

2. The method for directly charging a battery according to claim 1, wherein when the charging system further comprises a photovoltaic inverter and a power grid, and the voltage conversion controller is further communicatively connected to the photovoltaic inverter, positive electrodes of the photovoltaic panel series branches are further respectively electrically connected to the positive input terminal of the photovoltaic inverter, and negative electrodes of the photovoltaic panel series branches are further respectively electrically connected to the negative input terminal of the photovoltaic inverter; and when an AC output terminal of the photovoltaic inverter is electrically connected to the power grid, the method for directly charging a battery further comprises the following step S6 after step S5: generating a third control signal, and transmitting the third control signal to the photovoltaic inverter, so that the photovoltaic inverter enters a battery charging mode in cooperation with the voltage conversion controller after responding to the third control signal: on the one hand, according to the desired battery charging current of the secondary battery, adjusting a magnitude of the current transmitted to the secondary battery in real time according to the maximum power point voltage, so that the battery charging voltage always operates at the maximum power point, and on the other hand, inverting and transmitting the remaining photovoltaic power generation amount of the photovoltaic panel voltage conversion circuit to the power grid;
and/or, the charging system further comprises a DC-DC buck-boost circuit, the voltage conversion controller is also communicatively connected to said DC-DC buck-boost circuit, and the positive electrodes of the photovoltaic panel series branches are also respectively electrically connected to a positive electrode input terminal of said DC-DC buck-boost circuit, the negative electrodes of the photovoltaic panel series branches are also respectively electrically connected to a negative electrode input terminal of the DC-DC buck-boost circuit, the positive electrode output terminal of the DC-DC buck-boost circuit is electrically connected to the positive electrode of the secondary battery, when the negative electrode output terminal of the DC-DC buck-boost circuit is electrically connected to the negative electrode of the secondary battery, the method for directly charging a battery further comprises the following step after step S5: generating an eighth control signal and transmitting the eighth control signal to the DC-DC buck-boost circuit, so that the DC-DC buck-boost circuit enters a battery charging mode in cooperation with the voltage conversion controller after responding to the eighth control signal: on the one hand, according to the desired battery charging current of the secondary battery, adjusting a magnitude of the current transmitted to the secondary battery in real time according to the maximum power point voltage, so that the battery charging voltage always operates at the maximum power point; and on the other hand, transmitting the remaining photovoltaic power generation amount of the photovoltaic panel voltage conversion circuit to the secondary battery after bucking or boosting the voltage via the DC-DC buck-boost circuit.

3. The method for directly charging a battery according to claim 2, wherein after performing step S6, the method further comprises the following steps S711-S714:
S711: judging whether the desired battery charging voltage of the secondary battery matches the current maximum power point voltage of each photovoltaic panel series branch, and if NO, executing step S712;
S712: adjusting to reduce the current magnitude until the current magnitude is not larger than a preset current threshold, and executing step S713;
S713: generating a fourth control signal, transmitting the fourth control signal to the direct charging switch, so that the direct charging switch cuts off the charging loop after responding to the fourth control signal, and then executing step S714;
S714: returning to execute steps S1 to S6;
and/or, after performing step S6, the method further comprises the following steps S721-S726:
S721: if it is found according to battery status data of the secondary battery that the charging of the secondary battery needs to be stopped, executing step S722;
S722: executing step S723 after the adjusting to reduce the current magnitude until the current magnitude is not larger than the preset current threshold;
S723: generating a fourth control signal, transmitting the fourth control signal to the direct charging switch, so that the direct charging switch cuts off the charging loop after responding to the fourth control signal, and then executing step S724;
S724: judging whether the current number of series-connected photovoltaic panels of each of the photovoltaic panel series branches is equal to a maximum adjustable integer value, if YES, executing step S726, and otherwise, executing step S725;
S725: generating a fifth control signal, and transmitting the fifth control signal to the photovoltaic panel voltage conversion circuit, so that the photovoltaic panel voltage conversion circuit respectively adjusts the number of series-connected photovoltaic panels of each of the photovoltaic panel series branches to the maximum adjustable integer value after responding to the fifth control signal, and then executing step S726;
S726: generating a sixth control signal, and transmitting the sixth control signal to the photovoltaic inverter, so that the photovoltaic inverter, after responding to the sixth control signal, enters a normal working mode: inverting and transmitting all the photovoltaic power generation amount of the photovoltaic panel voltage conversion circuit to the power grid.

4. The method for directly charging a battery according to claim 1, wherein the step of, the step of, according to a desired battery charging voltage of the secondary battery, a current number of series-connected photovoltaic panels and a current maximum power point voltage of each of the photovoltaic panel series branches, determining a target number of series-connected photovoltaic panels which are of the photovoltaic panel series branch and enable the maximum power point voltage to match the desired battery charging voltage comprises:
judging whether the secondary battery can be charged according to the maximum power point voltage of each photovoltaic panel series branch as recorded in the latest unit time period;
if YES, determining the target number of series-connected photovoltaic panels which are of the photovoltaic panel series branch and enable the maximum power point voltage to match the desired battery charging voltage, according to the desired battery charging voltage of the secondary battery, the current number of series-connected photovoltaic panels and the current maximum power point voltage of each of the photovoltaic panel series branches, otherwise triggering to generate and display reminding information indicating that the secondary battery is not chargeable currently.

5. The method for directly charging a battery according to claim 1, wherein after judging that the one photovoltaic panel series branch or the at least two photovoltaic panel series branches are all currently in a normal condition, the method further comprises:
if the photovoltaic panel series branch or any of the at least two photovoltaic panel series branches is judged currently in an abnormal condition, triggering to generate and display reminding information indicating that the battery cannot be currently charged.

6. An apparatus for directly charging a battery based on photovoltaic panels, wherein the apparatus is adapted to be arranged in a voltage conversion controller of a charging system, where the charging system further includes a photovoltaic panel voltage conversion circuit, a direct charging switch and a secondary battery, where the photovoltaic panel voltage conversion circuit includes one photovoltaic panel series branch or at least two photovoltaic panel series branches, the one photovoltaic panel series branch or each of the at least two photovoltaic panel series branches comprises a plurality of series-connected photovoltaic panels; the photovoltaic voltage conversion circuit synchronously adjusts a number of series-connected photovoltaic panels of all the photovoltaic panel series branch and meanwhile re-combine the adjusted plurality of photovoltaic panels into at least one new photovoltaic panel series branch to charge the secondary battery or transmit electricity to the external, or the photovoltaic voltage conversion circuit only selects one of the photovoltaic panel series branches to charge the secondary battery and transmits the electricity on remaining photovoltaic panel series branches to the external; the voltage conversion controller respectively communicatively connects the photovoltaic panel voltage conversion circuit and the direct charging switch, a positive electrode of each photovoltaic panel series branch is electrically connected to a positive input terminal of the direct charging switch, a negative electrode of each photovoltaic panel series branch is electrically connected to a negative input terminal of the direct charging switch, the positive output terminal of the direct charging switch is electrically connected to the positive electrode of the secondary battery, and the negative output terminal of the direct charging switch is electrically connected to the negative electrode of the secondary battery;
the apparatus for directly charging a battery comprises a target number determination module, a first judgment module, a first trigger module, a second judgment module and a second trigger module;
the target number determination module is communicatively connected to the first judgment module and configured to, according to a desired battery charging voltage of the secondary battery, a current number of series-connected photovoltaic panels and a current maximum power point voltage of each of the photovoltaic panel series branches, determine a target number of series-connected photovoltaic panels which are of the photovoltaic panel series branch and enable the maximum power point voltage to match the desired battery charging voltage, and then activate the first judgment module;
the first judgment module is communicatively connected with the first trigger module and the second judgment module, respectively, and configured to judge whether the target number of series-connected photovoltaic panels is equal to the current number of series-connected photovoltaic panels, if YES, activate the second judgment module, otherwise, activate the first trigger module;
the first trigger module is communicatively connected with the second judgment module and configured to generate a first control signal according to the target number of series-connected photovoltaic panels, and transmit the first control signal to the photovoltaic panel voltage conversion circuit, so that the photovoltaic panel voltage conversion circuit respectively adjusts the number of series-connected photovoltaic panels of each photovoltaic panel series branch to the target number of series-connected photovoltaic panels after responding to the first control signal, and then activate the second judgment module;
the second judgment module is communicatively connected with the second trigger module and configured to judge whether the one photovoltaic panel series branch or the at least two photovoltaic panel series branches are all currently in a normal condition according to a current branch voltage and a current branch current of each photovoltaic panel series branch, and if YES, activate the second trigger module;
the second trigger module is configured to generate a second control signal, and transmit the second control signal to the direct charging switch, so that after responding to the second control signal, the direct charging switch enables the one photovoltaic panel series branch or the at least two photovoltaic panel series branches to form a charging loop with the secondary battery.

7. A charging system, wherein the charging system comprises a voltage conversion controller, a photovoltaic panel voltage conversion circuit, a direct charging switch and a secondary battery, wherein the photovoltaic panel voltage conversion circuit includes one photovoltaic panel series branch or at least two photovoltaic panel series branches, the one photovoltaic panel series branch or any of the at least two photovoltaic panel series branches comprises a plurality of series-connected and photovoltaic panels, the photovoltaic voltage conversion circuit may synchronously adjust a number of series-connected photovoltaic panels of all photovoltaic panel series branches and meanwhile re-combine the adjusted plurality of photovoltaic panels into at least one new photovoltaic panel series branch to charge the secondary battery or transmit electricity to the external, or the photovoltaic voltage conversion circuit only selects one of the photovoltaic panel series branches to charge the secondary battery and transmits the electricity on remaining photovoltaic panel series branches to the external, the voltage conversion controller respectively communicatively connects the photovoltaic panel voltage conversion circuit and the direct charging switch, a positive electrode of each photovoltaic panel series branch is electrically connected to a positive input terminal of the direct charging switch, a negative electrode of each photovoltaic panel series branch is electrically connected to a negative input terminal of the direct charging switch, the positive output terminal of the direct charging switch is electrically connected to the positive electrode of the secondary battery, and the negative output terminal of the direct charging switch is electrically connected to the negative electrode of the secondary battery;
the voltage conversion controller is used to implement the method for directly charging the battery according to claim 1.

8. The charging system according to claim 7, wherein when the charging system further comprises a photovoltaic inverter, the photovoltaic panel voltage conversion circuit includes K said photovoltaic panel series branches, where the photovoltaic panel series branches include N photovoltaic panels serially connected in sequence in a direction from a positive electrode to a negative electrode and M switches arranged in sequence in the direction from the positive electrode to the negative electrode direction, an m^{th} switch among the M switches in the direction from the positive electrode to the negative electrode is a first switch, an M^{th} switch among the M switches in the direction from the positive electrode to the negative electrode is a second switch, K represents a positive integer, M represents a positive integer not less than 2, and M represents a positive integer less than M;
the first switcher includes pin #1, pin #2, pin #3, pin #4, pin #5 and pin #6, where when the first switch is in a first state, only pin #3 is electrically connected with pin #4 and pin #2 is electrically connected with pin #6; when the first switch is in a second state, only pin #1 is electrically connected with pin #2 and pin #3 respectively, and pin #4 is electrically connected with pin #5;
the second switch includes pin #2, pin #3, pin #4, pin #5 and pin #6, wherein when the second switcher is in the first state, only pin #3 is electrically connected with pin #4 and pin #2 is electrically connected with pin #6; when the second switcher is in the second state, only pin #3 is electrically connected with pin #6 and pin #4 is electrically connected with pin #5;
the positive electrode of the (M+1)^{th} photovoltaic panel among the N photovoltaic panels in the direction from the positive electrode to the negative electrode is electrically connected with pin #3 of the M^{th} switch, the negative electrode of the M^{th} photovoltaic panel among the N photovoltaic panels in the direction from the positive electrode to the negative electrode is electrically connected to pin #4 of the M^{th} switch, the positive electrode of the (m+1)^{th} photovoltaic panel among the N photovoltaic panels in the direction from the positive electrode to the negative electrode is electrically connected to pin #3 of the m^{th} switch, and the negative electrode of the m^{th} photovoltaic panel among the N photovoltaic panels in the direction from the positive electrode to the negative electrode is electrically connected to pin #4 of the m^{th} switch; for the first photovoltaic panel series branch of the K photovoltaic panel series branches, the corresponding pin #1 of the m^{th} switch, the corresponding pins #2 of the M switches and the corresponding positive electrode of the first photovoltaic panel in the direction from the positive electrode to the negative electrode are respectively electrically connected to a positive electrode input terminal of the photovoltaic inverter, and the corresponding pins #6 of the M switches are respectively electrically connected to the positive electrode input terminal of the photovoltaic inverter;
for the k^{th} photovoltaic panel series branch in the K photovoltaic panel series branches, the corresponding pins #2 of the corresponding M switches and the positive electrode of the corresponding first photovoltaic panel in the direction from the positive electrode to the negative electrode are respectively electrically connected to pin #5 of the first switch in the (k−1)^{th} photovoltaic panel series branch in the direction from the positive electrode to the negative electrode, and pin #1 of the corresponding w^{th} switch in the direction from the positive electrode to the negative electrode is electrically connected to pin #5 of the (w+1)^{th} switch in the (k−1)^{th} photovoltaic panel series branch in the direction from the positive electrode to the negative electrode; the corresponding pins #6 of the M switches are respectively electrically connected to the positive electrode input terminal of the photovoltaic inverter, wherein k is a positive integer greater than 1 and not greater than K, and w is a positive integer greater than 1 and not greater than M;
for the K^{th} photovoltaic panel series branch of the K photovoltaic panel series branches, the corresponding pins #5 of the M switches are respectively electrically connected to a negative electrode input terminal of the photovoltaic inverter;
the x^{th} switch in each of the photovoltaic panel series branches in the direction from the positive electrode to the negative electrode is synchronously controlled by the voltage conversion controller; furthermore, when the x^{th} switch is in the first state, only the y^{th} switch in the direction from the positive electrode to the negative electrode can be in the second state, wherein x is a positive integer no greater than M, and y is a positive integer less than x.

9. A control device, wherein the control device comprises a memory, a processor and a transceiver, wherein the memory is used to store a computer program, the transceiver is used to transmit and receive a message, and the processor is used to read the computer program and implement the method for directly charging the battery according to claim 1.

10. A computer-readable storage medium, wherein the computer-readable storage medium stores instructions that, when executed on a computer, implement the method for directly charging the battery according to claim 1.
